(19) United States
(12) Patent Application Publication
(10) Pub. No.: US 2017/0343363 A1
(43) Pub. Date: Nov. 30, 2017

(54) ROUTE NAVIGATION SYSTEM, METHOD, AND RECORDING MEDIUM FOR COGNITIVE ENHANCEMENT

(71) Applicant: International Business Machines Corporation, Armonk, NY (US)

(72) Inventors: Itzhack Goldberg, Hadera (IL); James Robert Kozloski, New Fairfield, CT (US); Clifford A. Pickover, Yorktown Heights, NY (US)

(21) Appl. No.: 15/168,300

(22) Filed: May 31, 2016

(51) Int. Cl. G01C 21/34

(52) U.S. Cl. CPC G01C 21/34

(57) ABSTRACT

A route navigation method, system, and non-transitory computer readable medium, include a route navigation circuit configured to provide a navigation route for a user including navigation instructions, a route querying circuit configured to send queries to the user for a response from the user regarding information of the route, and a route query managing circuit configured to manage a delivery state of the queries sent to the user and to manage the user response such that the delivery state is modified so as to change a cognitive state of the user.

### BACKGROUND

The present invention relates generally to a route navigation system, and more particularly, but not by way of limitation, to a route navigation system for cognitive enhancement by facilitating route memorization and increased spatial understanding.

Conventionally, navigation systems create a passive state for a user in which the user follows the instructions of the system to arrive at a destination. The user of these conventional navigation systems has an increased likelihood to passively follow the navigation instructions to a wrong turn or even an accident. For example, death has resulted from a user passively following the navigation system into a lake or off a bridge.

That is, conventional navigation systems forgo the spatial awareness benefits for the brain that navigation without a navigation system enables.

Thus, there is a technical problem in the conventional techniques that the conventional techniques create a passive state for a user's brain while following the navigation instructions such that the user is more likely not to learn the navigation and be in an accident as a result of the passive state.

### SUMMARY

The inventors have considered the newly-identified technical problem and realized that there is a significant need for a navigation system for cognitive enhancement by transforming the conventional passive navigation systems to an active navigation system which combines educational parameters and configurations of conventional navigation systems to educate, train, enhance abilities and characteristics with respect to users engaged in spatial learning tasks while utilizing the navigation system.

Thus, the inventions have realized a technical solution to the newly identified technical problem by engaging the users in spatial learning tasks, thereby transforming the users' mind from a passive state to an active learning state.

In an exemplary embodiment, the present invention can provide a route navigation circuit configured to provide a navigation route for a user including navigation instructions, a route querying circuit configured to send queries to the user for a response from the user regarding information of the route, and a route query managing circuit configured to manage a delivery state of the queries sent to the user and to manage the user response such that the delivery state is modified so as to change a cognitive state of the user.

Further, in another exemplary embodiment, the present invention can provide a route navigation method including providing a navigation route for a user including navigation instructions, sending queries to the user for a response from the user regarding information of the route, and managing a delivery state of the queries sent to the user and managing the user response such that the delivery state is modified so as to change a cognitive state of the user.

Even further, in another exemplary embodiment, the present invention can provide a non-transitory computer-readable recording medium recording a route navigation program, the program causing a computer to perform: providing a navigation route for a user including navigation instructions, sending queries to the user for a response from the user regarding information of the route, and managing a delivery state of the queries sent to the user and managing the user response such that the delivery state is modified so as to change a cognitive state of the user.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a block diagram illustrating a configuration of a route navigation system 100.

FIG. 2 exemplarily shows a high level flow chart for a route navigation method 200.

FIG. 3 depicts a cloud computing node 10 according to an embodiment of the present invention.

FIG. 4 depicts a cloud computing environment 50 according to another embodiment of the present invention.

FIG. 5 depicts abstraction model layers according to an embodiment of the present invention.

### DETAILED DESCRIPTION OF THE EXEMPLARY EMBODIMENTS

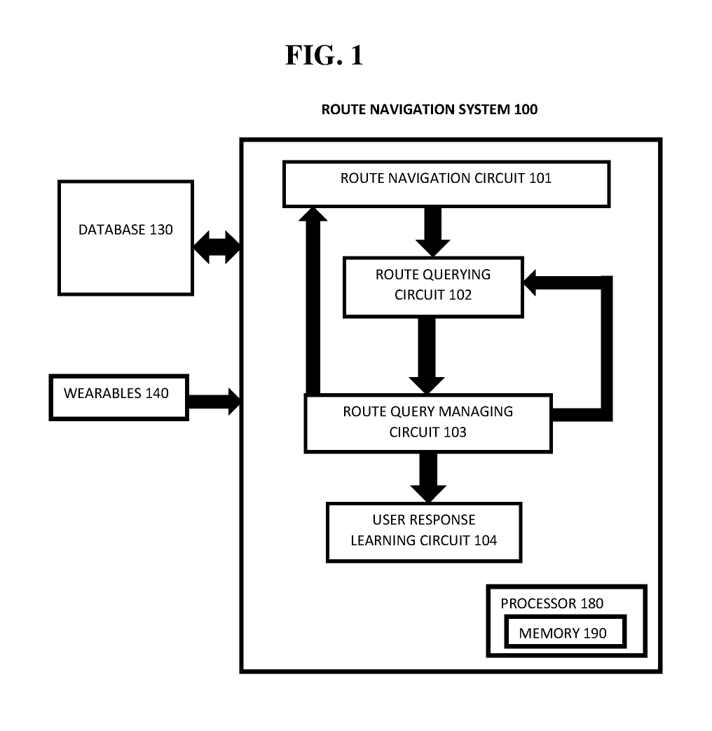

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

With reference now to FIG. 1, the route navigation system 100 includes a route navigation circuit 101, a route querying circuit 102, a route query managing circuit 103, and a user response learning circuit 104. The route navigation system 100 also includes a processor 180 and a memory 190, with the memory 190 storing instructions to cause the processor 180 to execute each circuit of route navigation system 100. The processor and memory may be physical hardware components, or a combination of hardware and software components.

Although the route navigation system 100 includes various circuits, it should be noted that a route navigation system can include modules in which the memory 190 stores instructions to cause the processor 180 to execute each module of route navigation system 100.

Also, each circuit can be a stand-alone device, unit, module, etc. that can be interconnected to cooperatively produce a transformation to a result.

With the use of these various circuits, the route navigation system 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

Cognitive states are defined as functions of measures of a user's total behavior collected over some period of time from at least one personal information collector (including musculoskeletal gestures, speech gestures, eye movements, internal physiological changes, measured by imaging circuits, microphones, physiological and kinematic sensors in a high dimensional measurement space) within a lower dimensional feature space. In one exemplary embodiment, certain feature extraction techniques are used for identifying certain cognitive and emotional traits. Specifically, the reduction of a set of behavioral measures over some period of time to a set of feature nodes and vectors, corresponding to the behavioral measures' representations in the lower dimensional feature space, is used to identify the emergence of a certain cognitive state(s) over that period of time. One or more exemplary embodiments use certain feature extraction techniques for identifying certain cognitive states. The relationship of one feature node to other similar nodes through edges in a graph corresponds to the temporal order of transitions from one set of measures and the feature nodes and vectors to another. Some connected subgraphs of the feature nodes are herein also defined as a cognitive state. The present application also describes the analysis, categorization, and identification of these cognitive states by further feature analysis of subgraphs, including dimensionality reduction of the subgraphs, for example of graphical analysis, which extracts topological features and categorizes the resultant subgraph and its associated feature nodes and edges within a subgraph feature space.

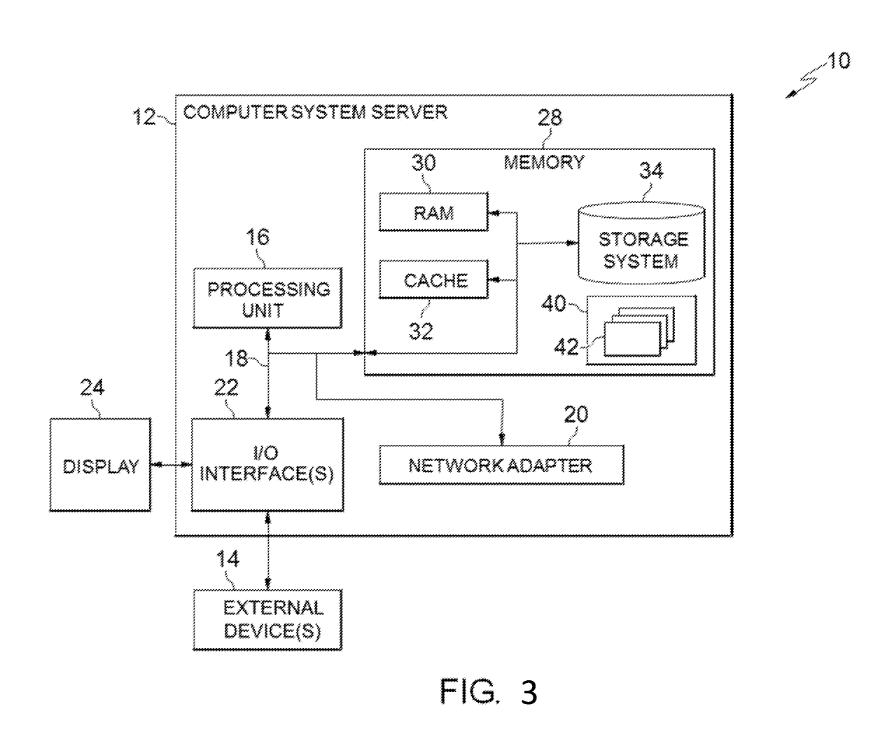

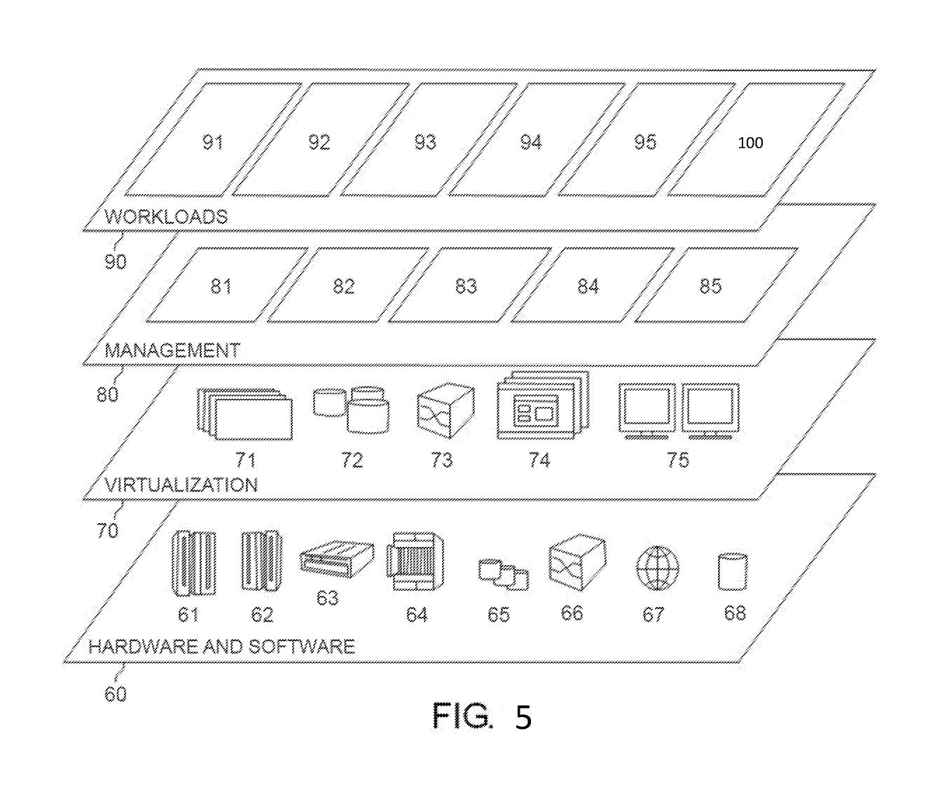

Although as shown in FIGS. 3-5 and as described later, the computer system/server 12 is exemplarily shown in cloud computing node 10 as a general-purpose computing circuit which may execute in a layer the route navigation system 100 (FIG. 5), it is noted that the present invention can be implemented outside of the cloud environment.

The route navigation circuit 101 provides a route for the user to navigate, for example, with turn-by-turn instructions, the route being stored or calculated from data of a database 130. The route can involve driving, flying, remote flying a drone, walking, jogging, etc.

As a user is following the instructions of the route for navigation of the route navigation circuit 101, the route querying circuit 102 queries the user for a response regarding information about the route. The queries can relate to forthcoming turns (e.g. road changes), hints, nature of stores along the road, etc.

The route query managing circuit 103 manages a nature and a frequency of the queries sent to the user and the user responses such that the nature and the frequency can be determined or modified, so as to engage the user and solidify familiarity (and memory) with the route and area (as well as to elevate a user's cognitive tone).

That is, the route query managing circuit 103 can adjust the nature of the query that is sent to the user. For example, based on prior user responses, it can be determined that the user is more cognitively engaged with the route and area if the route query managing circuit 103 causes the route querying circuit 102 to issue queries of a surrounding nature such as the types of stores, the road signs, landmarks, etc. In other words, the route query managing circuit 103 can cause the queries to be related to the area rather than the route, such that the user can have familiarity with not just the roads.

On the other hand, the route query managing circuit 103 can adjust the nature of the query such that the query sent to the user is regarding directional instructions in the route navigation.

Further, the route query managing circuit 103 can cause the route querying circuit 102 to issue a query for every single instructional message of the route. As the user answers correctly or is determined to be actively engaged with the route (i.e., no longer in a passive state) as determined by wearables 140 (or the like), the route query managing circuit 103 can adjust the frequency of the queries to every three-turn instructions, every five-turn instructions, etc. Thus, the route query managing circuit 103 adjusts the frequency of the queries based on the user's measured cognitive engagement with the route.

In other words, the system 100 can be coupled to wearables 140 which adjusts a user interface or route produced by the route navigation circuit 101 based on an estimate of any of a driver's arousal level, fear level, level of engagement, sleepiness, or perception of danger. In one embodiment, the route navigation interface may adapt itself and offer alternate routes as triggered by the route query managing circuit 103 when a driver is perceived as being too stressed by the current route, or when a driver's wearables indicate other dangers are present along the route.

Also, the route query managing circuit 103 can cause the route querying circuit 102 to send the queries when the risk level is low for the window of time in which to actually issue such queries (e.g. no traffic, predetermined time before the turn, traveling at a lower speed, not near cross-walks, or school bus, etc.).

The route query managing circuit 103 can also determine a number of correct consecutive answers or correct answers overall by the user to the queries. If the user answers a predetermined number of queries correctively consecutively or an overall number of correct answers is above a threshold value (i.e., a number of correct answers out of the total number of queries is greater than a predetermined percentage), the route query managing circuit 103 causes the route querying circuit 102 to issue queries at a lesser frequency.

The route query managing circuit 103 can also cause the route querying circuit 102 not to interrupt music playing from the same speakers that issues the query to the user. The route query managing circuit 103 can cause the music not to be interrupted based on the number of correct answers by the user, a cognitive state of the user determined from the wearables 140, an audio level of the music (i.e., louder music means the user wants to only listen to music), etc.

The user response learning circuit 104 receives the user answers to the queries and the nature and frequency modifications by the route query managing circuit 103 and the nature and frequencies may be learned for different cohorts of drivers based on the user's answers (e.g., autism, pre-Alzheimer's, elderly, people with spatial recognition challenges, people with brain injuries, drivers susceptible to distractions, etc.). In this manner, the user response learning circuit 104 can send learned frequency and nature of responses and queries to the database 130 such that a new user in the same cohort can have a pre-configured route navigation system 100.

The route query managing circuit 103 can further modify the queries to include cognitive measurement, cognitive training and game playing, and cognitive engagement to ensure people do not passively drive off a bridge (i.e., as a result of driving passively). For example, the route query managing circuit 103 can cause the route querying circuit 102 to act as a cognitive training app/game in which the user can receive a score to compare to other users of the same route.

It is noted that the user response learning circuit 104 can relate the voice with the route to a reporting system, for medical, aging population monitoring.

The route query managing circuit 103 can also remove voice and visual navigation cues, and provide navigation through the Socratic Method. In other words, a running dialogue can be engaged between the route querying circuit 102 and a user such as ““Do you know the way?” “Hmmm are you sure you want to turn up ahead or would it be better to go straight?” In this case, the system 100 and user may be viewed as “negotiating” the best route.

Further, the route querying circuit 102 need not be entirely artificial, and can represent one way to achieve safety and cognitive engagement even when an individual is slavishly following the directions on the Global Positioning System (GPS) screen (to his or her possible peril). The negotiation outcome is then represented through the GPS interface, and then may be then a better reflection of a user's inputs to the decision making process, potentially detecting dangerous conditions and reflecting them in the device display.

Also, in one embodiment, the system 100 can facilitate intuitive comparison and selection of calculated navigation routes so as to better familiarize a user and possibly even enhance spatial memory. That is, the route navigation circuit 101 may display a route guidance list on a monitor screen in an intuitive and organized manner so that a user can easily understand information regarding the maneuvering locations and actions associated with the route to the destination. The route guidance list is structured in a layered manner so that the information regarding the maneuvering actions at the locations closer to the current user position will be prioritized. The navigation system 100 displays the route guidance list in which the information regarding the maneuvering locations and actions may be dynamically changed in response to the changes of the current location of the user, along with learning about the user or user cohorts.

Further, the database 130 may include a neuropsychological assessment that includes routes, road names, directions, compass directions, etc.

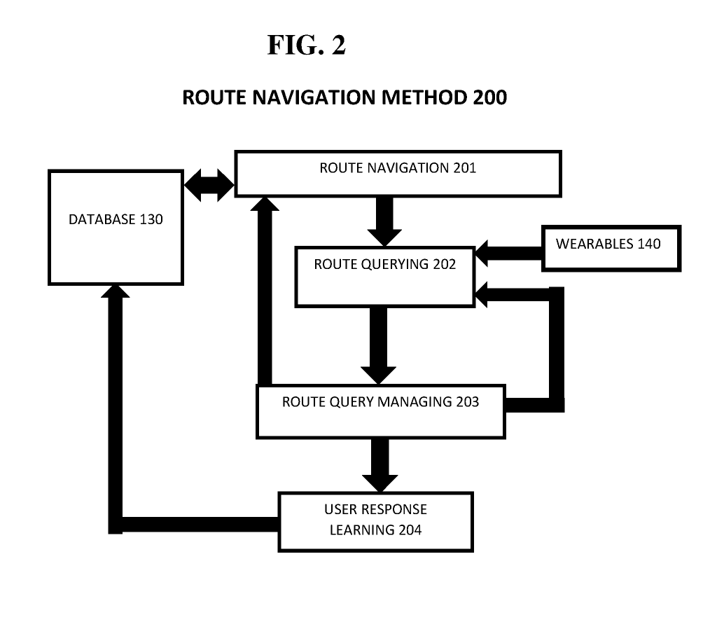

FIG. 2 shows a high level flow chart for a method 200 of route navigation.

Step 201 provides a route for a user to navigate with turn-by-turn instructions, the route being stored or calculated from data of a database 130.

As a user is following the instructions of the route for navigation of the route of Step 201, Step 202 queries the user for a response regarding information about the route.

Step 203 manages a nature and a frequency of the queries sent to the user and the user responses such that the nature and the frequency can be determined or modified so as to engage the user and solidify familiarity (and memory) with the route and area (as well as to elevate a user's cognitive tone).

Step 204 receives the user answers to the queries and the nature and frequency modifications by Step 203 and the nature and frequencies may be learned for different cohorts of drivers based on the user's answers (e.g., autism, pre-Alzheimer's, elderly, people with spatial recognition challenges, people with brain injuries, drivers susceptible to distractions, etc.). In this manner, Step 204 can send learned frequency and nature of responses and queries to the database 130 such that a new user in the same cohort can have a pre-configured route navigation method 200.

Of course, route navigation technology is a great aid and assistant to many drivers and indeed allows one to skip the need to read the map and prepare mentally for the trip. With the embodiments described herein, the driver is optionally making more decisions about the routes. For instance, the system 100 can advise the driver about the upcoming milestones/exits/streets etc. and give the user a chance to decide which way to go (preferably by voice as to not distract him too much). The system 100 can advise the driver that the choice he made might extend the travel time by that many minutes/hours and offer “correction” if the “mistake” he makes might cost him more than a predetermined threshold. This way the user is not a passive user but an engaged one, and it will help the driver to hone his navigational skills and be able to test them without too much risk of going astray as the GPS can always recalculate effective routes. The cognitive navigation system 100 will cater to each user per his abilities and tracked skills. Therefore, the embodiments disclosed herein enable the user to transform from a passive state of following the instructions to an active state of learning.

Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

As shown in FIG. 3, computer system/server 12 in cloud computing node 10 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

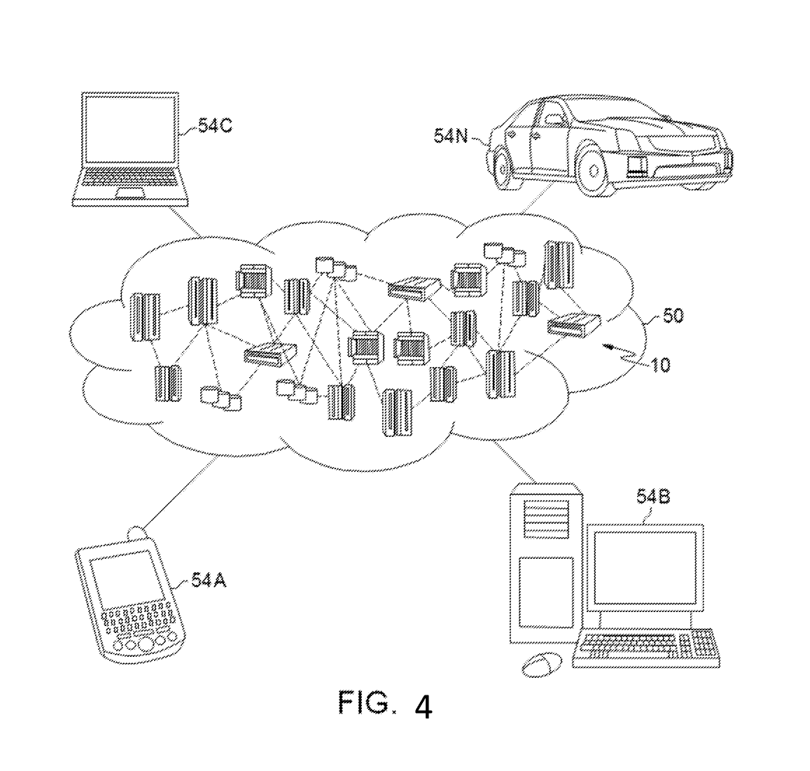

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 8 are intended to be illustrative only and that computing nodes 10 and cloud computing environment 50 can communicate with any type of computerized circuit over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and data store software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the route navigation system 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A route navigation system comprising:
a route navigation circuit configured to provide a navigation route for a user including navigation instructions;
a route querying circuit configured to send queries to the user for a response from the user regarding information of the route; and
a route query managing circuit configured to manage a delivery state of the queries sent to the user and to manage the user response, such that the delivery state is modified so as to change a cognitive state of the user.

2. The system of claim 1, wherein the delivery state includes a nature of the queries and a frequency of the queries.

3. The system of claim 1, further comprising a user response learning circuit configured to receive the response from the user corresponding to the delivery state of the queries and to learn a delivery state for different cohorts of users based on the user response and the delivery state.

4. The system of claim 1, wherein the navigation route is for any one of:
driving;
flying;
remote flying a drone;
walking; and
jogging.

5. The system of claim 1, wherein the queries relate to:
a forthcoming turn;
a road change;
a hint;
a landmark; and
information of an area of the route.

6. The system of claim 1, wherein the route query managing circuit manages the queries such that the route querying circuit sends the queries when a risk level is low for the user.

7. The system of claim 1, wherein the route query managing circuit adjusts a frequency of the queries based on a cognitive engagement of the user with the route as measured by wearables.

8. The system of claim 1, wherein the route query managing circuit determines a number of correct answers by the user to the queries and a total number of queries sent, and
wherein the route query managing circuit causes the route querying circuit to send the queries at a lesser frequency if the user answers a predetermined percentage of the queries correctly.

9. The system of claim 1, wherein the route query managing circuit causes the route querying circuit not to interrupt audio other than the queries playing during the navigation route.

10. The system of claim 1, wherein the route query managing circuit determines a number of correct answers to the queries by the user and a total number of queries sent, and
wherein the route query managing circuit causes the route querying circuit not to interrupt audio other than the queries if the user answers a predetermined percentage of the queries correctly.

11. A route navigation method comprising:
providing a navigation route for a user including navigation instructions;
sending queries to the user for a response from the user regarding information of the route; and
managing a delivery state of the queries sent to the user and managing the user response, such that the delivery state is modified so as to change a cognitive state of the user.

12. The method of claim 11, wherein the delivery state includes a nature of the queries and a frequency of the queries.

13. The method of claim 11, further comprising receiving the response from the user corresponding to the delivery state of the queries and learning a delivery state for different cohorts of users based on the user response and the delivery state.

14. The method of claim 11, wherein the managing further manages the queries such that the sending sends the queries when a risk level is low for the user.

15. The method of claim 1, wherein the managing further determines a number of correct answers to the queries by the user and a total number of queries sent, and
wherein the managing causes the sending to send the queries at a lesser frequency if the user answers a predetermined percentage of the queries correctly.

16. A non-transitory computer-readable recording medium recording a route navigation program, the program causing a computer to perform:
providing a navigation route for a user including navigation instructions;
sending queries to the user for a response from the user regarding information of the route; and
managing a delivery state of the queries sent to the user and managing the user response, such that the delivery state is modified so as to change a cognitive state of the user.

17. The non-transitory computer-readable recording medium of claim 16, wherein the delivery state includes a nature of the queries and a frequency of the queries.

18. The non-transitory computer-readable recording medium of claim 16, further comprising receiving the response from the user corresponding to the delivery state of the queries and learning a delivery state for different cohorts of users based on the user response and the delivery state.

19. The non-transitory computer-readable recording medium of claim 16, wherein the managing further manages the queries such that the sending sends the queries when a risk level is low for the user.

20. The non-transitory computer-readable recording medium of claim 16, wherein the managing further determines a number of correct answers to the queries by the user and a total number of queries sent, and
wherein the managing causes the sending to send the queries at a lesser frequency if the user answers a predetermined percentage of the queries correctly.
